(19) United States
(12) Patent Application Publication
(10) Pub. No.: US 2015/0291913 A1
(43) Pub. Date: Oct. 15, 2015

(54) COMPOSITE DETERGENT GRANULES AND LAUNDRY COMPOSITIONS COMPRISING THE SAME

(71) Applicant: The Procter & Gamble Company, Cincinnati, OH (US)

(72) Inventors: HongSing TAN, Beijing (CN); Daitao GENG, Beijing (CN); Koen Mariette Albert SCHAMP, Overijse (BE); Zhe GUAN, Beijing (CN)

(21) Appl. No.: 14/683,156

(22) Filed: Apr. 10, 2015

(30) Foreign Application Priority Data
Apr. 10, 2014 (CN) PCT/CN2014/075049

(51) Int. Cl. C11D 1/37; C11D 3/12; C11D 11/00

(52) U.S. Cl. CPC C11D 1/37; C11D 11/0017; C11D 3/124

(57) ABSTRACT

This relates to a composite detergent granule having a core particle covered by a coating layer, as well as a granular detergent composition containing the same. The core particle contains a mixture of silica, a C₁₀-C₂₀ linear alkyl benzene sulphonate (LAS) and optionally a C₁₀-C₂₀ linear or branched alkylethoxy sulfate (AES). The coating layer contains AES. Such a composite detergent granule is characterized by high surfactant activity, improved water hardness tolerance, fast surfactant release, and superior dissolution profile.

### FIELD OF THE INVENTION

The present invention relates to granular detergent compositions containing one or more detersive detergent granules. Particularly, it relates to a composite detergent granule having a core particle and a coating layer, which is characterized by high surfactant activity, improved water hardness tolerance, fast surfactant release, and superior dissolution profile.

### BACKGROUND OF THE INVENTION

Granular laundry detergent compositions of today may contain detergent granules formed either by agglomeration process or by spray drying process. The agglomeration process can produce detergent granules with high concentrations of cleaning actives or surfactants that are particularly useful for forming laundry detergents with superior cleaning performance. The currently available high active agglomerated detergent granules are typically formed of linear alkyl benzene sulphonate surfactants. However, such surfactants have limited tolerance of water hardness. When dissolved, linear alkyl benzene sulphonate surfactants is capable of forming water-insoluble precipitation with Ca²⁺ ions that are present in hard water, thereby reducing the cleaning effectiveness of the detergent composition.

Alkylethoxy sulfate surfactants have relatively higher tolerance toward hard water. Therefore, they can be mixed with linear alkyl benzene sulphonate surfactants as co-surfactants to improve overall hard water tolerance of the detergent compositions. WO9814557A discloses detergent agglomerates formed by mixing the liquid acid precursor of linear alkyl benzene sulphonate surfactants (which is referred to as HLAS) and the liquid alkylethoxy sulfate with large amounts of powdered sodium tripolyphosphate (STPP), ground soda ash (i.e., sodium carbonate), and ground sodium sulfate. However, the detergent agglomerates so formed have relatively low surfactant activity, e.g., having a total surfactant content of not more than 50%. Such low active detergent agglomerates cannot meet the increasing market demand for high active detergents. Attempt to increase the total surfactant level in such low active detergent agglomerates may be limited by the fact that alkylethoxy sulfate is thermally instable, which requires significantly large amount of sodium carbonate to ensure its thermal stability. Further, the co-agglomerated linear alkyl benzene sulphonate and alkylethoxy sulfate particles upon dissolution simultaneously release both surfactants into the washing liquor. The dissolved linear alkyl benzene sulphonate is still vulnerable to precipitation with Ca²⁺ ions in hard water, although such vulnerability is reduced due to the presence of alkylethoxy sulfate in the solution which can sequester some of the Ca²⁺ ions and prevent them from contacting linear alkyl benzene sulphonate.

There is therefore a continuing need for high active detergent granules having improved water hardness tolerance.

### SUMMARY OF THE INVENTION

The present invention provides a composite detergent granule containing both the linear alkyl benzene (LAS) and alkylethoxy sulfate (AES) surfactants. The LAS and AES components of the composite detergent granules of the present invention are arranged in a unique spatial relationship, i.e., with LAS in the core and AES in the coating layer, so to augment protection of the LAS component against the Ca²⁺ ions in hard water washing environments, thereby maximizing the water hardness tolerance of the surfactants.

Further, silica (preferably hydrophilic silica) is employed as an inorganic carrier to maximize surfactant loading and increase the total surfactant content of such composite detergent granule to about 50 wt % or more, preferably about 60 wt % or more, and more preferably about 70 wt % or more. Still further, the present invention successfully breaks through conventional formulation barrier for LAS and AES hybrid detergent particles, by replacing sodium carbonate (which functions as an alkaline medium to improve thermal stability of AES) with LAS, and further by adding caustic solution (up to 3%) or solid caustic to ensure thermal stability of AES.

The resulting composite detergent granule of the present invention is characterized by various advantages including high surfactant activity, fast surfactant release, and superior dissolution profile, which in turn lead to flash suds that delight the consumer during hand-wash cycles.

In one aspect, the present invention relates to a composite detergent granule containing a core particle and a coating layer thereover, which is characterized by a median particle size ranging from about 100 μm to about 800 μm and a total surfactant content ranging from about 50% to about 80% by total weight thereof. The median particle size of such composite detergent granule preferably ranges from about 150 μm to about 800 μm, more preferably from 250 μm to about 600 μm, and most preferably about 350 μm to about 450 μm. The core particle has a median particle size ranging from about 130 microns to about 710 microns, preferably from about 220 microns to about 540 microns, and more preferably from about 310 microns to about 400 microns, and wherein the coating layer has an average thickness ranging from about 5 microns to about 50 microns, preferably from about 10 microns to about 40 microns, and more preferably from about 20 microns to about 25 microns.

The core particle of such composite detergent granule contains a mixture of silica, a C₁₀-C₂₀ linear alkyl benzene sulphonate surfactant (hereinafter “LAS”) and optionally a C₁₀-C₂₀ linear or branched alkylethoxy sulfate surfactant (hereinafter “AES”). In a specific embodiment of the present invention, the core particle consists essentially of silica and LAS, substantially free of AES. In another specific embodiment of the present invention, the core particle contains silica, LAS and AES. The silica contained by the core particle is preferably, but not necessarily, a hydrophilic silica, and it may be present in the composite detergent granule at an amount ranging from about 20 wt % to about 50 wt %, more preferably from about 25 wt % to about 40 wt %, and most preferably from about 30 wt % to about 35 wt %.

The coating layer of such detergent granule contains AES. The coating layer may contain an alkali metal hydroxide, which functions to ensure thermal stability of AES. Such alkali metal hydroxide is preferably present in the composite detergent granule at an amount ranging from about 0.01 wt % to about 5 wt %, more preferably from about 0.1 wt % to about 3 wt %, and most preferably from about 1 wt % to about 2 wt %.

The total surfactant content of the composite detergent granule preferably ranges from about 60 wt % to about 75 wt %, and more preferably from about 65 wt % to about 70 wt %. Preferably, the weight ratio of LAS over AES ranges from about 3:1 to about 1:3, preferably from about 2.5:1 to about 1:2.5, and more preferably from about 1.5:1 to about 1:1.5. When the core particle also contains AES, it is preferred that the weight ratio of AES in the core particle over AES in the coating layer ranges from about 1:10 to about 10:1, preferably from about 1:2 to about 5:1, more preferably from about 1:1 to about 3:1, and most preferably from about 2:1 to about 2.5:1.

The composite detergent granule of present invention may have a moisture content ranging from about 1 wt % to about 3 wt %, and preferably from about 2 wt % to about 3 wt %. Further, it may have a bulk density ranging from about 300 g/L to about 900 g/L, preferably from about 400 g/L to about 800 g/L, more preferably from about 450 g/L to about 550 g/L.

In a preferred but not necessary embodiment of the present invention, the composite detergent granule further includes a second coating layer over the above-mentioned coating layer, which contains silica.

The composite detergent granule of the present invention may consist essentially of silica, LAS, AES, water, and optionally the alkali metal hydroxide. Alternatively, it may further contain one or more water-soluble inorganic salt(s) of carbonate and/or sulfate in the amount ranging from about 0 wt % to about 25 wt %, preferably from about 0.1 wt % to about 10 wt %, and more preferably from about 1 wt % to about 5 wt %.

In a particularly preferred embodiment of the present invention, the composite detergent granule comprises, in total weight, from about 20 wt % to about 35 wt % silica, from about 20 wt % to about 40 wt % of LAS, and from about 30 wt % to about 50 wt % of AES. More specifically, from about 20 wt % to about 35 wt % of AES (by total weight of the granule) is in the core particle, and from about 5 wt % to about 20 wt % of AES is in the coating layer.

In another aspect, the present invention relates to a granular detergent composition containing from about 1 wt % to about 99 wt % of composite detergent granules as described hereinabove. Such granular detergent composition is preferably a hand-washing laundry detergent composition.

In still another aspect, the present invention relates to a process for making a composite detergent granule, comprising the steps of:
(a) forming a core particle by mixing silica with LAS, and optionally with AES, preferably by using a high shear mixer having a tip speed ranging from about 2 msec to about 50 msec, preferably from about 4 msec to about 25 msec, and more preferably from about 6 msec to about 18 msec; and
(b) forming a coating layer over such core particle by using a coating composition containing AES, preferably by using a medium shear mixer having a tip speed ranging from about 0.3 msec to about 5 msec, preferably from about 1 msec to about 3 msec, and more preferably from about 1.5 msec to about 2 msec,
   while the composite detergent granule so formed has a median particle size ranging from about 70 μm to about 1200 μm and a total surfactant content ranging from about 50% to about 80% by total weight thereof.

The coating composition is preferably a paste containing at least about 50 wt % AES in a liquid carrier, which is preferably water.

These and other aspects of the present invention will become more apparent upon reading the following drawings and detailed description of the invention.

### BRIEF DESCRIPTION OF THE DRAWINGS

FIGS. 1-3 are illustrative diagrams showing various components of the composite detergent particles according to various embodiments of the present invention. Please note that these diagrams are only presented to conceptually illustrate various components of the inventive particles. They are not intended to, and should not be used to, define or limit scope of the present invention in any manner.

FIGS. 4 and 5 are graphs comparing the release of LAS in hard water (20 gpg) over time (10 seconds to 40 seconds) by various inventive composite detergent particles within the scope of the present invention with that by various comparative detergent particles not within the scope of the present invention.

### DETAILED DESCRIPTION OF THE INVENTION

As used herein, articles such as “a” and “an” when used in a claim, are understood to mean one or more of what is claimed or described. The terms “include”, “includes” and “including” are meant to be non-limiting.

As used herein, the term “composite detergent granule,” “composite detergent particle,” “hybrid detergent granule,” or “hybrid detergent particle” refer to particles containing two or more surfactants, which are preferably located in different and discrete regions in the particles.

As used herein, the term “median particle size” refers to the Median Weight Particle Size (Dw50) of a specific particle as determined by the Sieve Test specified hereinafter using a sample of such particles. The term “particle size distribution” as used herein refers to a list of values or a mathematical function that defines the relative amount, typically by mass or weight, of particles present according to size, as measured also by the Sieve Test specified hereinafter.

As used herein, the term “layer” means a partial or complete coating of a layering material over the outer surfaces of a particulate or granular material, or at least a portion of such outer surfaces.

As used herein, the term “a granular detergent composition” refers to a solid composition, such as granular or powder-form all-purpose or heavy-duty washing agents for fabric, as well as cleaning auxiliaries such as bleach, rinse aids, additives, or pre-treat types.

The term “bulk density” as used herein refers to the uncompressed, untapped powder bulk density, as measured by the Bulk Density Test specified hereinafter.

As used herein, the term “substantially free of” means that that the component of interest is present in an amount less than 0.1% by weight.

As used herein, the term “water hardness” refers to the presence of uncomplexed calcium (Ca²⁺) ions arising from water and/or soils on dirty fabrics; more generally and typically, “water hardness” also includes the presence of other uncomplexed cations (Mg²⁺) having the potential to precipitate under alkaline conditions, which tend to diminish the surfactancy and cleaning capacity of surfactants. Further, the term “high water hardness” is a relative term and for the purposes of the present invention, means at least 12 grams of calcium ions per gallon of water (gpg, “American grain hardness” units).

As used herein, the term “carrying capacity” means the ability of a dry material, such as, for non-limiting example a dry detergent composition, to use water or other liquids as a structural component. Carrying capacity also reflects the ability of the other dry material to be able to carry high amounts of water or other liquids and still behave as a solid powder.

The term “Dissolution Residue Value” as used herein refers to the percentage (%) residue left on a sieve after a standard amount of a raw material, e.g., a granular detergent composition, is mixed with water and then filtered through the sieve, according to the Dissolution Residue Test described hereinafter.

In all embodiments of the present invention, all percentages or ratios are calculated by weight, unless specifically stated otherwise. The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

### Core Particle

The core particle of the composite detergent granule of the present invention contains a mixture of silica and LAS.

Silica has both internal and external surface area, which allows for easy absorption of liquids and has a large liquid loading capacity. Hydrophilic silica is especially effective at adsorbing water. Any silica particles with suitable particle sizes can be employed for practice of the present invention. Specifically, the silica particles have a dry particle size distribution Dw50 ranging from about 0.1 μm to about 100 μm, preferably from about 1 μm to about 50 μm, more preferably from about 2 μm to about 40 μm, and most preferably from 4 μm to about 20 μm.

Preferably but not necessarily, the silica particles are composed of hydrophilic silica that can be hydrated upon contact with the washing liquor to expand volumetrically. Without being bound by any theory, it is believed that the volumetric expansion of hydrophilic silica helps to up disintegration of the composite detergent granule and leads to faster dispersion and dissolution of the surfactants into the washing liquor. Therefore, hydrophilic silica, and preferably precipitated hydrophilic silica, is incorporated into the core particles of the present invention together with LAS therein to provide higher surfactant activity and faster dispersion or dissolution benefits. A particularly preferred hydrophilic precipitated silica material for practice of the present invention is commercially available from Evonik Corporation under the tradename Sipernat®340.

The silica is preferably present in the composite detergent granules in an amount ranging from about 20 wt % to about 50 wt %, more preferably from about 25 wt % to about 40 wt %, and most preferably from about 30 wt % to about 35 wt %, by total weight of the composite detergent particles.

LAS, preferably a sodium salt of LAS having an alkyl group containing from about 11 to about 13 carbon atoms, is mixed with silica to form the core particles. The core particles may comprise only LAS with silica, substantially free of any other surfactants. Alternatively, the core particles may contain LAS, silica, and one or more additional surfactants, such as anionic surfactants, nonionic surfactants, cationic surfactants, or a combination thereof.

Additional anionic surfactants suitable to be added to the core particles in addition to LAS include AES, C₁₀-C₂₀ linear or branched alkyl sulfates (hereinafter “AS”), C₁₀-C₂₀ linear or branched alkyl sulphonates, C₁₀-C₂₀ linear or branched alkyl phosphates, C₁₀-C₂₀ linear or branched alkyl phosphonates, C₁₀-C₂₀ linear or branched alkyl carboxylates, and salts and mixtures thereof. Nonionic surfactants useful for incorporation into the core particles include C₈-C₁₈ alkyl alkoxylated alcohols having an average degree of alkoxylation from about 1 to about 20, preferably from about 3 to about 10, and most preferred are C₁₂-C₁₈ alkyl ethoxylated alcohols having an average degree of alkoxylation of from about 3 to about 10; and mixtures thereof. Suitable cationic surfactants are mono-C₆₋₁₈ alkyl mono-hydroxyethyl di-methyl quaternary ammonium chlorides, more preferred are mono-C₈₋₁₀ alkyl mono-hydroxyethyl di-methyl quaternary ammonium chloride, mono-C₁₀₋₁₂ alkyl mono-hydroxyethyl di-methyl quaternary ammonium chloride and mono-C₁₀ alkyl mono-hydroxyethyl di-methyl quaternary ammonium chloride.

In a preferred but not necessary embodiment of the present invention, the core particles of the present invention comprise both LAS and AES mixed with silica (as shown in FIG. 2).

In addition to surfactants and silica, the core particles may, but do not need to, further comprise one or more carbonate and/or sulfate salts, preferably alkaline metal carbonates and/or sulfates such as sodium carbonate, potassium carbonate, sodium bicarbonate, potassium bicarbonate, sodium sulfate, potassium sulfate, and the like. The amount of carbonate and/or sulfate salts in the core particles may range from about 0% to about 25%, preferably from about 0.1% to about 10%, and more preferably from about 1% to about 5%, measured by total weight of the final composite detergent granules. Optionally, particle size of the salt(s) may be reduced by a milling, grinding or a comminuting step with any apparatus known in the art for milling, grinding or comminuting of granular or particulate compositions. In a particularly preferred embodiment of the present invention, the core particles are substantially free of carbonate and sulfate salts.

The core particles of the present invention may comprise other cleaning actives, such as chelants, polymers, enzymes, bleaching agents, and the like. However, the core particles according to the preferred embodiment of the present invention are substantially free of such other cleaning actives.

The core particle may be characterized by a median particle size ranging from about 100 microns to about 500 microns, preferably from about 200 microns to about 300 microns, and more preferably from about 250 microns to about 280 microns.

### Coating Layers

A coating layer containing AES is formed over the core particle described hereinabove. Such coating layer may cover only a portion of the core particle, or the entire outer surface of the core particle. The coating layer is preferably a continuous layer, but it can also be discontinuous and covering discrete regions of the outer surface of the core particle.

The AES used for forming the coating layer can be either linear or branched, and it preferably has an average degree of ethoxylation ranging from about 0.1 to about 5.0, preferably from about 0.5 to about 3.0, and more preferably from about 1 to about 2. In a particularly preferred but not necessary embodiment of the present invention, the coating layer is formed of AE1S which is an alkylethoxy sulfate with an average degree of ethoxylation of about 1.

In order to improve thermal stability of the AES in the coating layer, it is desirable to formulate an alkali metal hydroxide, preferably sodium or potassium hydroxide and more preferably sodium hydroxide (i.e., caustic), into the coating layer. Such alkali metal hydroxide may be present in an amount ranging from about 0.01 wt % to about 5 wt %, more preferably from about 0.1 wt % to about 3 wt %, and most preferably from about 1 wt % to about 2 wt %, measured by the total weight of the final composite detergent granules. In a specific embodiment of the present invention, a caustic solution is sprayed onto the core particles when the core particles are mixed with the AES paste or solution in the mixer. In an alternative embodiment, dry caustic is premixed with the AES paste or solution, and the premix is then coated over the core particles to form the coating layer.

The coating layer may one or more additional surfactants, such as LAS or AS anionic surfactants, nonionic surfactants, cationic surfactants, or a combination thereof, as mentioned hereinabove. Further, the coating layer may comprise other cleaning actives, such as chelants, polymers, enzymes, bleaching agents, and the like. In a particularly preferred embodiment, the coating layer is substantially free of other surfactants besides AES and other cleaning actives. More preferably, the coating layer consists essentially of AES and the alkali metal hydroxide.

The coating layer may have an average thickness ranging from about 5 microns to about 100 microns, preferably from about 10 microns to about 50 microns, and more preferably from about 15 microns to about 30 microns. The average thickness of the coating layer is determined indirectly (rather than directly) as the difference between the mean particle size of the composite detergent granule and the mean particle size of the core particle (i.e., before it is coated with the coating layer).

In order to improve flowability and minimize gelling or caking of the composite detergent granules of the present invention, it is also desirable to form a second coating layer over the above-mentioned coating layer by dusting with silica powders or fine particles. The silica used for forming such second coating layer can be the same or different from the silica particles used for forming the core particles. In a preferred embodiment, both the core particles and the second coating layer are formed using the same hydrophilic silica particles.

The final composite detergent granule so formed may have a median particle size ranging from about 70 μm to about 1200 μm, preferably from about 100 μm to about 1000 μm, more preferably from about 250 μm to about 500 μm, and most preferably about 300 μm to about 425 μm. The total surfactant content therein is at least 50%, preferably from about 50% to about 80%, by total weight thereof. The bulk density of such composite detergent granule may range from 300 g/L to 900 g/L, preferably from 400 g/L to 800 g/L, more preferably from 450 g/L to 550 g/L.

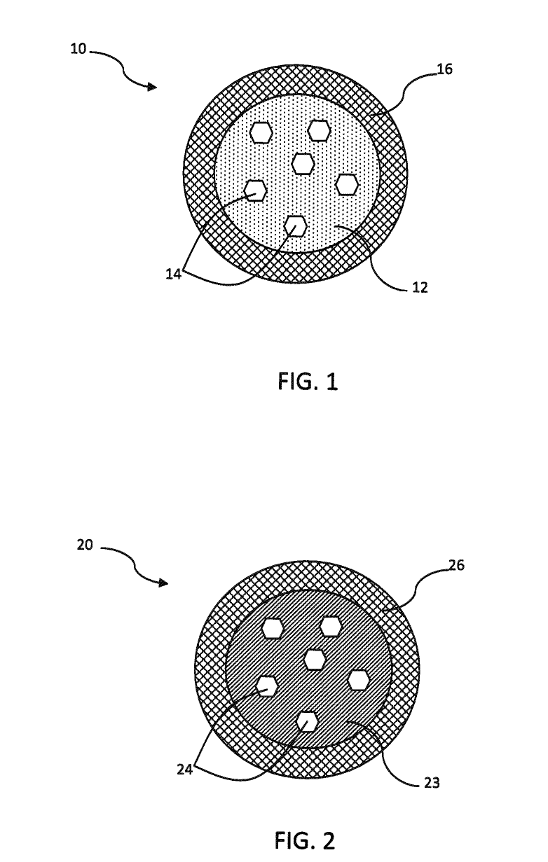

FIG. 1 shows a composite detergent particle 10 according to one embodiment of the present invention. Specifically, such particle 10 contains a core particle 12 that is formed of a mixture of LAS and silica 14. A coating layer 16, which is formed of AES, covers at least some portion of, and preferably the majority of, the outer surface area of the core particle 12.

FIG. 2 shows another composite detergent particle 20 according to another embodiment of the present invention, having a core particle 23 formed of a mixture of LAS, AES and silica 24 covered by a coating layer 26 formed of AES.

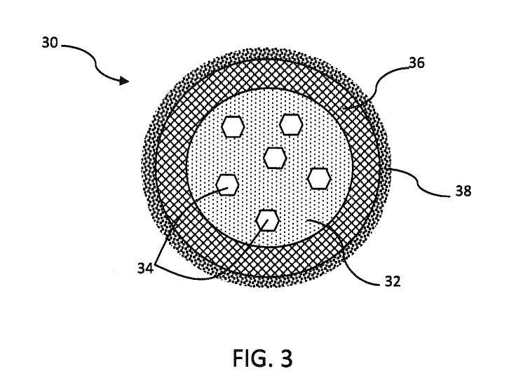

FIG. 3 shows yet another composite detergent particle 30 according to yet another embodiment of the present invention, which includes a core particle 32 formed of a mixture of

LAS and silica 34 and a coating layer 36 formed of AES, with a second coating layer 38 formed of silica, which covers at least some portion of, and preferably the majority of, the outer surface area of the coating layer 36.

### Granular Detergent Composition

The above-described composite detergent granules are particularly useful for forming high active granular detergent compositions of improved water hardness resistance, fast surfactant release and better dissolution or dispersion. Such composite detergent granules may be provided in a granular detergent composition in an amount ranging from about 1% to about 99%, preferably from about 2% to about 80%, and more preferably from about 5% to about 50% by total weight of the granular detergent composition.

The granular detergent composition may comprise one or more additional surfactants that are added directly therein, i.e., independent of the structured particles. The additional surfactants can be same as those already included in the composite detergent granules, or they can be different. The same types of anionic surfactants, non-ionic surfactants and cationic surfactants as described hereinabove are also suitable for directly addition into the granular detergent composition.

The granular detergent compositions of the present invention may further comprise a water-swellable cellulose derivative. Suitable examples of water-swellable cellulose derivatives are selected from the group consisting of substituted or unsubstituted alkyl celluloses and salts thereof, such as ethylcellulose, hydroxyethyl cellulose, hydroxypropyl methyl cellulose, methyl cellulose, carboxyl methyl cellulose (CMC), cross-linked CMC, modified CMC, and mixtures thereof. Preferably, such cellulose derivative materials can rapidly swells up within about 10 minutes, preferably within about 5 minutes, more preferably within about 2 minutes, even more preferably within about 1 minute, and most preferably within about 10 seconds, after contact with water. The water-swellable cellulose derivatives can be incorporated into the structured particles of the present invention together with the hydrophilic silica, or they can be incorporated into the granular detergent compositions independent of the structured particles, in an amount ranging from about 0.1% to about 5% and preferably from about 0.5% to about 3%. Such cellulose derivatives may further enhance the mechanical cleaning benefit of the granular detergent compositions of the present invention.

The granular detergent compositions may optionally include one or more other detergent adjunct materials for assisting or enhancing cleaning performance, treatment of the substrate to be cleaned, or to modify the aesthetics of the detergent composition. Illustrative examples of such detergent adjunct materials include: (1) inorganic and/or organic builders, such as carbonates (including bicarbonates and sesquicarbonates), sulphates, phosphates (exemplified by the tripolyphosphates, pyrophosphates, and glassy polymeric meta-phosphates), phosphonates, phytic acid, silicates, zeolite, citrates, polycarboxylates and salts thereof (such as mellitic acid, succinic acid, oxydisuccinic acid, polymaleic acid, benzene 1,3,5-tricarboxylic acid, carboxymethyloxysuccinic acid, and soluble salts thereof), ether hydroxypolycarboxylates, copolymers of maleic anhydride with ethylene or vinyl methyl ether, 1,3,5-trihydroxy benzene-2,4,6-trisulphonic acid, 3,3-dicarboxy-4-oxa-1,6-hexanedioates, polyacetic acids (such as ethylenediamine tetraacetic acid and nitrilotriacetic acid) and salts thereof, fatty acids (such as C_{12-C}₁₈ monocarboxylic acids); (2) chelating agents, such as iron and/or manganese-chelating agents selected from the group consisting of amino carboxylates, amino phosphonates, polyfunctionally-substituted aromatic chelating agents and mixtures therein; (3) clay soil removal/anti-redeposition agents, such as water-soluble ethoxylated amines (particularly ethoxylated tetraethylene-pentamine); (4) polymeric dispersing agents, such as polymeric polycarboxylates and polyethylene glycols, acrylic/maleic-based copolymers and water-soluble salts thereof of, hydroxypropylacrylate, maleic/acrylic/vinyl alcohol terpolymers, polyethylene glycol (PEG), polyaspartates and polyglutamates; (5) optical brighteners, which include but are not limited to derivatives of stilbene, pyrazoline, coumarin, carboxylic acid, methinecyanines, dibenzothiphene-5,5-dioxide, azoles, 5- and 6-membered-ring heterocycles, and the like; (6) suds suppressors, such as monocarboxylic fatty acids and soluble salts thereof, high molecular weight hydrocarbons (e.g., paraffins, haloparaffins, fatty acid esters, fatty acid esters of monovalent alcohols, aliphatic C₁₈-C₄₀ ketones, etc.), N-alkylated amino triazines, propylene oxide, monostearyl phosphates, silicones or derivatives thereof, secondary alcohols (e.g., 2-alkyl alkanols) and mixtures of such alcohols with silicone oils; (7) suds boosters, such as C₁₀-C₁₆ alkanolamides, C₁₀-C₁₄ monoethanol and diethanol amides, high sudsing surfactants (e.g., amine oxides, betaines and sultaines), and soluble magnesium salts (e.g., MgCl₂, MgSO₄, and the like); (8) fabric softeners, such as smectite clays, amine softeners and cationic softeners; (9) dye transfer inhibiting agents, such as polyvinyl pyrrolidone polymers, polyamine N-oxide polymers, copolymers of N-vinylpyrrolidone and N-vinylimidazole, manganese phthalocyanine, peroxidases, and mixtures thereof; (10) enzymes, such as proteases, amylases, lipases, cellulases, and peroxidases, and mixtures thereof; (11) enzyme stabilizers, which include water-soluble sources of calcium and/or magnesium ions, boric acid or borates (such as boric oxide, borax and other alkali metal borates); (12) bleaching agents, such as percarbonates (e.g., sodium carbonate peroxyhydrate, sodium pyrophosphate peroxyhydrate, urea peroxyhydrate, and sodium peroxide), persulfates, perborates, magnesium monoperoxyphthalate hexahydrate, the magnesium salt of metachloro perbenzoic acid, 4-nonylamino-4-oxoperoxybutyric acid and diperoxydodecanedioic acid, 6-nonylamino-6-oxoperoxycaproic acid, and photoactivated bleaching agents (e.g., sulfonated zinc and/or aluminum phthalocyanines); (13) bleach activators, such as nonanoyloxybenzene sulfonate (NOBS), tetraacetyl ethylene diamine (TAED), amido-derived bleach activators including (6-octanamidocaproyl)oxybenzenesulfonate, (6-nonanamidocaproyl)oxybenzenesulfonate, (6-decanamidocaproyl)oxybenzenesulfonate, and mixtures thereof, benzoxazin-type activators, acyl lactam activators (especially acyl caprolactams and acyl valerolactams); and (9) any other known detergent adjunct ingredients, including but not limited to carriers, hydrotropes, processing aids, dyes or pigments, and solid fillers.

### Process for Making Composite Detergent Granules

The composite detergent granules of the present invention can be formed by well known processes, preferably by agglomeration processes using suitable mixing devices known in the art. Any suitable mixing apparatus capable of handling viscous paste can be used as the mixer described hereinabove for practice of the present invention. Suitable apparatus includes, for example, high-speed pin mixers, ploughshare mixers, paddle mixers, twin-screw extruders, Teledyne compounders, etc. The mixing process can either be carried out intermittently in batches or continuously.

In a particularly preferred but not necessary embodiment of the present invention, the agglomeration process is carried out in two steps, including a first step of forming the core particles using a high shear mixer and then a second step of forming the coating layer using a medium shear mixer. Such a two-step agglomeration processing employing mixers of different shear rate is particularly effective in ensuring that the composite detergent granules so formed have an optimal particle size, e.g., a median particle size ranging from about 70 μm to about 1200 μm.

Specifically, the core particles are formed by mixing silica powder with LAS paste, and optionally with AES paste, preferably by using a high shear mixer characterized by a tip speed ranging from about 2 msec to about 50 msec, preferably from about 4 msec to about 25 msec, and more preferably from about 6 msec to about 18 msec. Subsequently, the core particles are coated with a liquid or paste composition containing AES in a medium shear mixer characterized by a tip speed ranging from about 0.3 msec to about 5 msec, preferably from about 1 msec to about 3 msec, and more preferably from about 1.5 msec to about 2 msec, thereby forming composite detergent granules of the present invention. Such composite granules can be further coated with silica via a dusting step.

Optionally, any oversize lumps are removed, preferably by a mogensen screen, and recycled via a grinder or lump-breaker back to the higher shear mixer or the medium shear mixer. The resulting agglomerates or granules are dried to remove moisture that may be present in excess of about 5 wt %, preferably in excess of about 4%, more preferably in excess of about 3%, and most preferably in excess of about 2 wt %. Further, any fines can be optionally removed and recycled to the high shear mixer.

### Process for Making the Granular Detergent Compositions Comprising the Composite Detergent Granules

The granular detergent composition, which is provided in a finished product form, can be made by mixing the composite detergent granules of the present invention with a plurality of other particles containing the above-described additional surfactants, cellulose derivatives, and detergent adjunct materials. Such other particles can be provided as spray-dried particles, agglomerated particles, and extruded particles. Further, the additional surfactants, cellulose derivatives, and detergent adjunct materials can also be incorporated into the granular detergent composition in liquid form through a spray-on process.

### Process for Using the Granular Detergent Compositions

The granular detergent compositions of the present invention can be used for either machine washing or hand washing of fabrics. It is particular suitable for use in a hand-washing context. For hand-washing, the laundry detergent is typically diluted by a factor of from about 1:100 to about 1:1000, or about 1:200 to about 1:500 by weight, by placing the laundry detergent in a container along with wash water to form a laundry liquor. The wash water used to form the laundry liquor is typically whatever water is easily available, such as tap water, river water, well water, etc. The temperature of the wash water may range from about 0° C. to about 40° C., preferably from about 5° C. to about 30° C., more preferably from 5° C. to 25° C., and most preferably from about 10° C. to about 20° C., although higher temperatures may be used for soaking and/or pretreating.

The laundry detergent and wash water is usually agitated to evenly disperse and/or either partially or completely dissolve the detergent and thereby form a laundry liquor. Such agitation forms suds, typically voluminous and creamy suds. The dirty laundry is added to the laundry liquor and optionally soaked for a period of time. Such soaking in the laundry liquor may be overnight, or for from about 1 minute to about 12 hours, or from about 5 minutes to about 6 hours, or from about 10 minutes to about 2 hours. In a variation herein, the laundry is added to the container either before or after the wash water, and then the laundry detergent is added to the container, either before or after the wash water. The method herein optionally includes a pre-treating step where the user pre-treats the laundry with the laundry detergent to form pre-treated laundry. In such a pre-treating step, the laundry detergent may be added directly to the laundry to form the pre-treated laundry, which may then be optionally scrubbed, for example, with a brush, rubbed against a surface, or against itself before being added to the wash water and/or the laundry liquor. Where the pre-treated laundry is added to water, then the diluting step may occur as the laundry detergent from the pre-treated laundry mixes with the wash water to form the laundry liquor.

The laundry is then hand-washed by the user who may or may not use one or more hand-held washing devices, such as washboards, brushes, or rods. The actual hand-washing duration may range from about 10 seconds to about 30 minutes, preferably from about 30 seconds to about 20 minutes, more preferably from about 1 minute to about 15 minutes, and most preferably from about 2 minutes to about 10 minutes. Once the laundry is hand-washed, then the laundry may be wrung out and put aside while the laundry liquor is either used for additional laundry, poured out, etc. The rinse water is then added to form a rinse bath, and then it is common practice to agitate the laundry to remove the surfactant residue. The laundry may be soaked in the rinse water and then wrung out and put aside. The number of rinses when using the liquid laundry detergent herein is typically from about 1 to about 3, or from about 1 to about 2. In a particularly preferred embodiment of the present invention, the rinse is carried out in a single rinse step or cycle.

### TEST METHODS

The following techniques must be used to determine the properties of the detergent granules and detergent compositions of the invention in order that the invention described and claimed herein may be fully understood.

### Test 1: Bulk Density Test

The granular material bulk density is determined in accordance with Test Method B, Loose-fill Density of Granular Materials, contained in ASTM Standard E727-02, “Standard Test Methods for Determining Bulk Density of Granular Carriers and Granular Pesticides,” approved Oct. 10, 2002.

### Test 2: Sieve Test

This test method is used herein to determine the particle size distribution of the agglomerated detergent granule's of the present invention. The particle size distribution of the detergent granules and granular detergent compositions are measured by sieving the granules through a succession of sieves with gradually smaller dimensions. The weight of material retained on each sieve is then used to calculate a particle size distribution.

This test is conducted to determine the Median Particle Size of the subject particle using ASTM D 502-89, “Standard Test Method for Particle Size of Soaps and Other Detergents”, approved May 26, 1989, with a further specification for sieve sizes used in the analysis. Following section 7, “Procedure using machine-sieving method,” a nest of clean dry sieves containing U.S. Standard (ASTM E 11) sieves #8 (2360 μm), #12 (1700 μm), #16 (1180 μm), #20 (850 μm), #30 (600 μm), #40 (425 μm), #50 (300 μm), #70 (212 μm), and #100 (150 μm) is required. The prescribed Machine-Sieving Method is used with the above sieve nest. The detergent granule of interest is used as the sample. A suitable sieve-shaking machine can be obtained from W.S. Tyler Company of Mentor, Ohio, U.S.A. The data are plotted on a semi-log plot with the micron size opening of each sieve plotted against the logarithmic abscissa and the cumulative mass percent (Q3) plotted against the linear ordinate.

An example of the above data representation is given in ISO 9276-1:1998, “Representation of results of particle size analysis—Part 1: Graphical Representation”, Figure A.4. The Median Weight Particle Size (Dw50) is defined as the abscissa value at the point where the cumulative weight percent is equal to 50 percent, and is calculated by a straight line interpolation between the data points directly above (a50) and below (b50) the 50% value using the following equation:

D_{w}50=10[Log(Dₐ₅₀)−(Log(Dₐ₅₀)−Log(D_{b50}))*(Qₐ₅₀−50%)/(Qₐ₅₀−Q_{bso})]

where Qₐ₅₀ and Q_{b50} are the cumulative weight percentile values of the data immediately above and below the 50^{th} percentile, respectively; and Dₐ₅₀ and D_{b50} are the micron sieve size values corresponding to these data. In the event that the 50^{th} percentile value falls below the finest sieve size (150 μm) or above the coarsest sieve size (2360 μm), then additional sieves must be added to the nest following a geometric progression of not greater than about 1.5, until the median falls between two measured sieve sizes.

### EXAMPLES

### Example 1

### Process for Making Composite Detergent Granules

The composite detergent granules of the present invention can be made by the following exemplary process:

An aqueous surfactant LAS paste having a detergent activity of about 78% and a water content of about 21% is pumped via a positive displacement pump into a Lödige CB 55 at a rate of about 1.95-3.5 ton/hr. The viscosity of the paste is about 25000 cps at a temperature of about 70° C. In parallel, an aqueous AE1S surfactant paste is pumped via separate positive displacement pump into the same mixer at a rate of about 1.46-2.63 ton/hr. At the same time, a powder stream of silica (Evonik) is also fed to the Lödige CB55 mixer at a rate of about 1.55 ton/hr. Also flowing into the same mixer are two streams containing the recycle of the classification of the agglomerates, one containing wet coarse particles and the other dry fine particles. The main stream of agglomerates leaving CB55 mixer enters Lödige KM4200 where the AE1 s paste is pumped via a positive displacement pump at a rate of about 0.49-0.88 ton/hr to coat the agglomerate. The agglomerate leaving the mixer is then dried in a controlled temperature fluid bed (inlet air temperature of about 105° C.) with an air exit temperature of about 50° C-55° C. After drying for an average residence time of approximately 15 minutes, the agglomerates are cooled in a second fluid bed to a powder exit temperatures below about 45° C. The cool dry product leaving the cooler is classified through mesh sieves and the desired particles sizes stored in a silo.

The agglomerates made by this example have a total detergent surfactant activity of about 70% and a density of about 450 g/L, with compositions similar to those listed in Table I below.

### Example 2

### Exemplary Composite Detergent Granules

The following table shows exemplary composite detergent granules 1-3 according to the present invention.

TABLE I

| Ingredients (wt %) | | Sample 1 | Sample 2 | Sample 3 |
|---|---|---|---|---|
| AE1S | Core | 18.75 | 26.25 | 33.75 |
| | Shell | 6.25 | 8.75 | 11.25 |
| | Total | 25.00 | 35.00 | 45.00 |

| | | | |
|---|---|---|---|
| LAS | 45.00 | 35.00 | 25.00 |
| Silica* | 24.18 | 24.18 | 24.18 |
| Misc. | 2.78 | 2.78 | 2.78 |
| Water | 2.50 | 2.50 | 2.50 |
| Total | 100.00 | 100.00 | 100.00 |

*Sipernat ®340 silica commercially available from Evonik.

One hundred seventy seven grams (177 g) of silica is weighed into the batch Tilt-a-pin mixer (Lödige) and mixed with the mixer running at 1200 rpm for about 2 seconds. Up to about 222 g to 400 g of aqueous surfactant LAS paste (having a detergent activity of 78%) and about 167 g to 300 g of AE1S paste is then injected into the mixer in series order, at a rate of about 35-50 ml/sec until all the paste are added. The mixture is then mixed for 2 seconds before stopping and manually transferred to Tilt-a-Plow (Lodige). The mixture is then mixed at a rate of 240 rpm for 2 seconds before about 56 g to 100 g of AE1S is pumped into the mixer to form a layer on the agglomerate. The product is then transferred to a batch fluidized bed drier, operating at inlet air velocity of about 0.8 m/s and drying air temperature of about 105° C. The product outcome yields the compositions described in Table I.

The above-formed granules have a bulk density of about 450 g/L and are free flowing particles that dissolve fast in water and give rise to flash suds, which is indicative of fast surfactant release. The process used hereinabove confirms the feasibility to increase total AE1S and LAS surfactant activity in the composite detergent granules of the present invention up to about 70 wt % by using silica.

### Example 3

### Exemplary Composite Detergent Granules by Partial Neutralization

TABLE II

| Ingredients (wt %) | | Sample 4 |
|---|---|---|
| AE1S | Core | 33.75 |
| | Shell | 11.25 |
| | Total | 45.00 |

| | |
|---|---|
| LAS | 15.00 |
| Silica* | 18 |
| carbonate | 16.8 |
| Misc. | 2.70 |
| Water | 2.50 |
| Total | 100.00 |

One hundred four grams (104 g) of silica and one hundred six grams (106 g) carbonate are weighed into the batch Tilt-a-pin mixer (Lödige) and mixed with the mixer running at 650 rpm for about 2 seconds. Up to about 90 grams of aqueous 50% partially neutralized LAS paste (prepared by pre-mixing 80 grams of HLAS (97% activity HLAS) and 9.7 grams of caustic solution (50% NaOH active)) and 253 grams of AE1S paste (having a detergent activity of 78%) is then injected into the mixer in series order, at a rate of about 35-50 ml/sec until all the paste are added. The mixture is then mixed for 2 seconds before stopping and manually transferred to Tilt-a-Plow (Lödige). The mixture is then mixed at a rate of 240 rpm for 2 seconds before about 63 grams of same AE1S paste is pumped into the mixer to form a layer on the agglomerate. The product is then transferred to a batch fluidized bed drier, operating at inlet air velocity of about 0.8 m/s and drying air temperature of about 105° C. The product outcome yields the compositions described in Table II.

The above process of making the co-surfactant particle demonstrate the ability to combine the use of partially neutralized LAS paste combined with carbonate (dry neutralization) to fully neutralize the total surfactant acid. The approach here avoids the need of preparing a fully neutralized LAS paste with very high viscosity and requires expensive pumping capability for paste delivery on manufacturing scale. The product here yields a bulk density of about 480 g/L and similar dissolution profile as those described in examples 2 above. The process used hereinabove confirms the feasibility to increase total AE1S and LAS surfactant activity in the composite detergent granules of the present invention up to about 60 wt % by using silica and carbonate.

### Example 4

### Water Hardness Tolerance Test

Two inventive examples of composite detergent granules within the scope of the present invention, one containing about 35 wt % AE1S and about 35 wt % LAS (“Sample A,” which is the same as Sample 2 in Example 2 hereinabove) and the other containing about 45 wt % AE1S and about 35 wt % LAS (“Sample B,” which is the same as Sample 3 in Example 2 hereinabove), are provided. Further, three comparative examples of detergent granules not within the scope of the present invention, including a detergent granule made by an agglomeration process containing about 70 wt % LAS (“Sample C”), a detergent granule that is formed by a spray-drying process containing about 80 wt % LAS (“Sample D”), and a detergent granule made by an agglomeration process containing about 26 wt % LAS (“Sample E”), are also provided. All the granules tested have a particle size distribution ranging from about 75 microns to about 1400 microns (“Full Particle Size”). Their compositions are listed hereinafter:

TABLE III

| | | Sample | Sample | Sample | Sample | Sample |
|---|---|---|---|---|---|---|
| Ingredients (wt %) | | A | B | C | D | E |
| AE1S | Core | 26.25 | 33.75 | — | — | — |
| | Shell | 8.75 | 11.25 | — | — | — |

| | | | | | |
|---|---|---|---|---|---|
| LAS | 45.00 | 35.00 | 70.00 | 80.00 | 26.00 |
| Silica* | 24.18 | 24.18 | 24.18 | — | — |
| Water | 2.50 | 2.50 | 2.50 | 2.50 | 1.20 |
| Carbonate | — | — | — | — | 70.00 |
| Sulphate | — | — | — | 3.50 | — |
| Silicate | — | — | — | 11.00 | — |
| Misc + balance | 2.78 | 2.78 | 2.78 | 3.00 | 2.80 |
| Total | 100.00 | 100.00 | 100.00 | 100.00 | 100.00 |

*Sipernat ®340 silica commercially available from Evonik.

Each of the above-listed Samples A-E of the Full Particle Size are divided into two batches, one representing the Full Particle Size range as indicated hereinabove, and the other being processed by screening out overs and fines using sieve #40(425 μm) and #60(250 μm) using sieve test method described in Test 2, to form samples with a narrower particle size distribution ranging from about 250 μm to about 425 μm.

Subsequently, the Samples A-E at the Full Particle Size and Samples A-E with the narrower particle size distribution ranging from about 250-425 μm are all tested for their LAS release using hard water containing about 20 grams per gallon calcium ions (20 gpg).

Specifically, the LAS release test is conducted as follows:

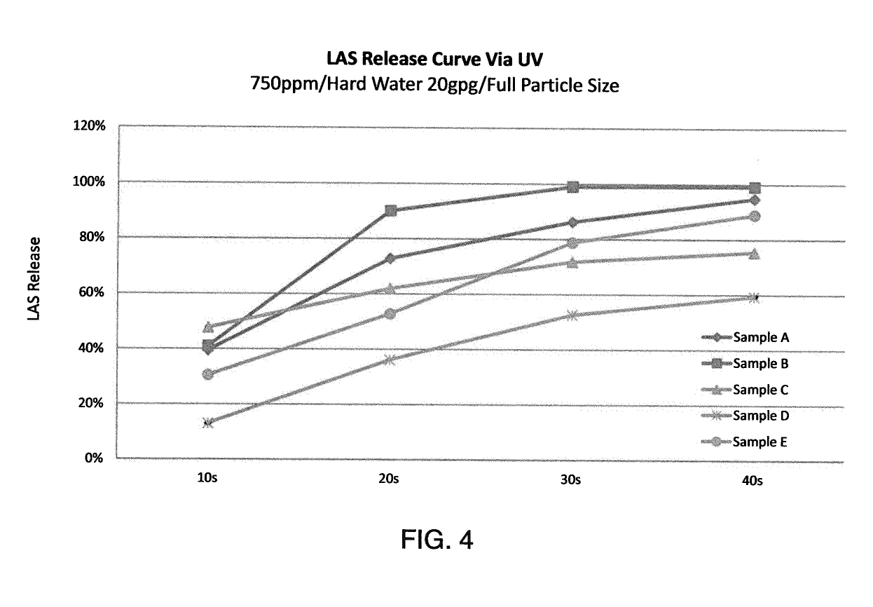

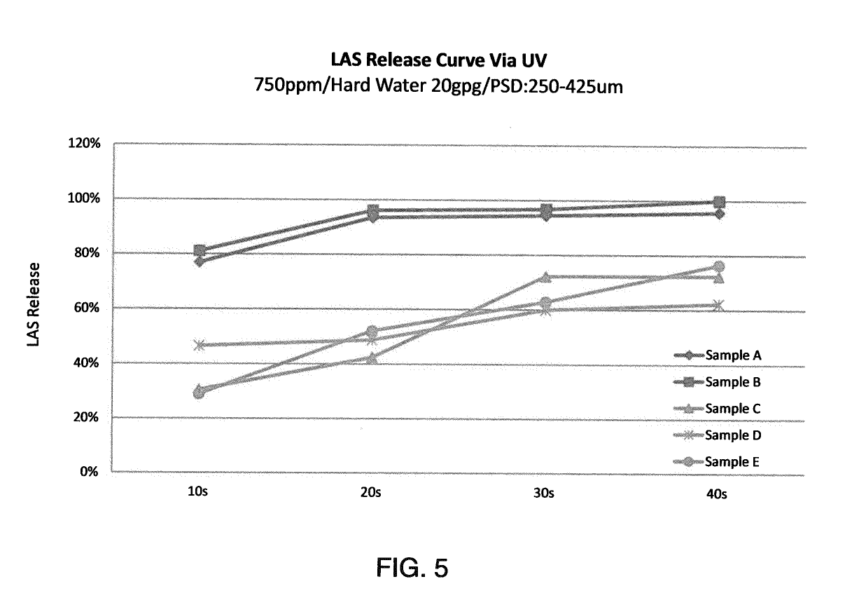

Three hundred milligrams of powder is first dissolved into 400 ml of de-ionized water in a beaker (500 ml Bomex) and mechanical stirrer (twin blade with about 5.2 cm diameter) running at 200 rpm. The stirrer is located about 2 cm from the bottom of the beaker. Note that before dissolution, fixed amount of calcium chloride solution is added to adjust the water hardness to specific hardness level e.g. 20 gpg in FIGS. 4 and 5. A four milliliter sample of dissolved solution at different time steps (e.g., 10 seconds, 20 seconds, 30 seconds etc.) is then extracted using a 10 ml syringe. The solution is then filtered through a syringe filter membrane with pore diameter of about 0.45 um (VWR, 0.45 μm Nylon). Each extracted solution is then loaded into a quartz cuvette (Sigma-Aldrich, Batch#:2265576-1) and placed into the cuvette holder of UV spectrometer (Shimadzu® UV-2401PC) to measure its absorbance level. Prior to measurement, the absorption spectra most sensitive for LAS are scanned and the wavelength peak of about 224 nm is determined for LAS absorption. The absorbance level of each extracted sample solution is then measured across each time point using the wavelength of 224 nm. The above process is repeated until there is no further change in absorbance level between samples, i.e., defined by difference between two time points of less than about 1%.

FIGS. 4 and 5 are graphs showing the release of LAS in hard water (20 gpg) over time (10 seconds to 40 seconds) by the inventive and comparative examples both at the Full Particle Size as well as the narrower particle size distribution of about 250-425 microns.

The inventive examples, i.e., Samples A and B, both demonstrates faster LAS release in hard water than the comparative examples that have either the same or even higher surfactant activity than the inventive examples. The faster LAS release in hard water is indicative of their higher water hardness tolerance. This is because the LAS released from the comparative examples is precipitated with calcium ions in the water and therefore losses its effectiveness, while the AE1S in the inventive examples acts as a co-surfactant to protect LAS against the calcium ions and preserve its cleaning effectiveness.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A composite detergent granule characterized by a median particle size ranging from 100μm to 800 μm and a total surfactant content ranging from 50% to 80% by total weight thereof, said composite detergent granule comprising a core particle and a coating layer over said core particle, wherein said core particle comprises a mixture of silica, a C₁₀-C₂₀ linear alkyl benzene sulphonate surfactant and optionally a C₁₀-C₂₀ linear or branched alkylethoxy sulfate surfactant, wherein said coating layer comprises the C₁₀-C₂₀ linear or branched alkylethoxy sulfate surfactant.

2. The composition detergent granule of claim 1, characterized by a weight ratio of the C₁₀-C₂₀ linear alkyl benzene sulphonate surfactant over the C₁₀-C₂₀ linear or branched alkylethoxy sulfate surfactant that ranges from 3:1 to 1:3, preferably from 2.5:1 to 1:2.5, and more preferably from 1.5:1 to 1:1.5.

3. The composite detergent granule of claim 1, wherein the mixture of the core particle comprises silica and the C₁₀-C₂₀ linear alkyl benzene sulphonate surfactant and is substantially free of the C₁₀-C₂₀ linear or branched alkylethoxy sulfate surfactant.

4. The composite detergent granule of claim 1, wherein the mixture of the core particle comprises silica, the C₁₀-C₂₀ linear alkyl benzene sulphonate surfactant and the C₁₀-C₂₀ linear or branched alkylethoxy sulfate surfactant.

5. The composite detergent granule of claim 4, characterized by a weight ratio of the C₁₀-C₂₀ linear or branched alkylethoxy sulfate surfactant in the core particle over the C₁₀-C₂₀ linear or branched alkylethoxy sulfate surfactant in the coating layer ranging from 1:10 to 10:1, preferably from 1:2 to 5:1, more preferably from 1:1 to 3:1, and most preferably from 2:1 to 2.5:1.

6. The composite detergent granule of claim 1, wherein the silica is a hydrophilic silica, which is preferably present in the composite detergent granule at an amount ranging from 20 wt % to 50 wt %, more preferably from 25 wt % to 40 wt %, and most preferably from 30 wt % to 35 wt %.

7. The composite detergent granule of claim 1, having: (1) a median particle size ranging from 150 μm to about 800 μm, preferably from 250 μm to 600 and most preferably about 350 μm to about 450 μm; (2) a total surfactant content ranging from 60 wt % to 80wt %, and preferably from 65 wt % to 70wt %; and/or (2) a moisture content ranging from 1 wt % to 3 wt %, and preferably from 2 wt % to 3 wt %.

8. The composite detergent granule of claim 1, wherein the coating layer further comprises an alkali metal hydroxide, which is preferably present in the composite detergent granule at an amount ranging from 0.01 wt % to 5 wt %, more preferably from 0.1 wt % to 3 wt %, and most preferably from 1 wt % to 2 wt %

9. The composite detergent granule of claim 1, further comprising a second coating layer over said coating layer, wherein said second coating layer comprises silica.

10. The composite detergent granule of claim 1, consisting essentially of silica, the C₁₀-C₂₀ linear alkyl benzene sulphonate surfactant, the C₁₀-C₂₀ linear or branched alkylethoxy sulfate surfactant, water, and optionally an alkali metal hydroxide.

11. The composite detergent granule of claim 1, further comprising one or more water-soluble inorganic salt(s) of carbonate and/or sulfate in the amount ranging from 0 wt % to 25 wt %, preferably from 0.1 wt % to 10 wt %, and more preferably from 1 wt % to 5 wt %.

12. The composite detergent granule of claim 1, wherein the core particle has a median particle size ranging from 130 microns to 710 microns, preferably from 220 microns to 540 microns, and more preferably from 310 microns to 400 microns, and wherein the coating layer has an average thickness ranging from 5 microns to 50 microns, preferably from 10 microns to 40 microns, and more preferably from 20 microns to 25 microns.

13. The composite detergent granule of claim 1, having a bulk density ranging from 300 g/L to 900 g/L, preferably from 400 g/L to 800 g/L, more preferably from 450 g/L to 550 g/L.

14. The composite detergent granule of claim 1, comprising in total weight from 30 wt % to 35 wt % silica, 20 wt % to 40 wt % of the C₁₀-C₂₀ linear alkyl benzene sulphonate surfactant, and 30 wt % to 50 wt % of the C₁₀-C₂₀ linear or branched alkylethoxy sulfate surfactant, wherein 20 wt % to 35 wt % of the C₁₀-C₂₀ linear or branched alkylethoxy sulfate surfactant is in the core particle, and wherein 5 wt % to 20 wt % of the C₁₀-C₂₀ linear or branched alkylethoxy sulfate surfactant is in the coating layer.

15. A granular detergent composition comprising from 1 wt % to 99 wt % of the composite detergent granules according to claim 1.

16. The granular detergent composition of claim 15, which is a hand-washing laundry detergent composition.

17. A process for making a composite detergent granule, comprising the steps of:
(a) forming a core particle by mixing silica with a C₁₀-C₂₀ linear alkyl benzene sulphonate, and optionally a C₁₀-C₂₀ linear or branched alkylethoxy sulfate; and
(b) forming a coating layer over said core particle by using a coating composition comprising the C₁₀-C₂₀ linear or branched alkylethoxy sulfate, wherein the composite detergent granule so formed has a median particle size ranging from 70 μm to 1200 μm and a total surfactant content ranging from 50% to 80% by total weight thereof.

18. The process of claim 17, wherein the coating composition is a paste comprising at least 50 wt % of the C₁₀-C₂₀ linear or branched alkylethoxy sulfate in a liquid carrier, which is preferably water.

19. The process of claim 17, wherein step (a) is carried out in a high shear mixer having a tip speed ranging from 2 msec to 50 msec, preferably from 4 msec to 25 msec, and more preferably from 6 msec to 18 msec, and wherein step (b) is carried out in a medium shear mixer having a tip speed ranging from 0.3 msec to 5 msec, preferably from 1.0 msec to 3.0 msec, and more preferably from 1.5 msec to 2.0 msec.
